(19) United States
(12) Patent Application Publication
(10) Pub. No.: US 2021/0230046 A1
(43) Pub. Date: Jul. 29, 2021

(54) OPTICAL CAP COMPONENT

(71) Applicant: NIPPON ELECTRIC GLASS CO., LTD., Otsu-shi (JP)

(72) Inventors: Yoshimasa MATSUSHITA, Otsu-shi (JP); Fumio SATO, Otsu-shi (JP)

(21) Appl. No.: 17/209,297

(22) Filed: Mar. 23, 2021

Related U.S. Application Data
(63) Continuation of application No. 16/342,003, filed on Apr. 15, 2019.

(30) Foreign Application Priority Data
Nov. 2, 2016 (JP) 2016-215161
Feb. 8, 2017 (JP) 2017-021009

(51) Int. Cl. C03C 3/12; G02B 1/115; G01N 21/3504; C03C 4/10; G02B 3/00

(52) U.S. Cl. CPC C03C 3/122; G02B 1/115; G01N 21/3504; G01N 2201/0639; G02B 3/00; C03C 2204/00; C03C 4/10

(57) ABSTRACT

Provided is an optical cap component that can give good sensitivity to an infrared light absorption-based optical gas sensor. An optical cap component includes: a window member formed of a lens-shaped infrared transmitting glass; and a cap member including a cylindrical sidewall portion having openings on both a distal end side and a base end side, wherein the window member is fixed to cover the opening on the distal end side of the cap member.

### TECHNICAL FIELD

The present invention relates to optical cap components for use in gas sensors, gas alarms, gas concentration meters, and so on.

### BACKGROUND ART

Recently, attention has been focused on air quality in a room and, therefore, there is a need for a small, inexpensive, and highly maintainable gas sensor. In response to this need, various gas sensors using semiconductors, ceramics or so on have been developed. For example, infrared light absorption-based optical sensors excellent in both sensitivity and stability are used as CO₂ sensors.

In such an infrared light absorption-based optical gas sensor, a sleeve-like or cap-like metallic case is mounted around a photoreceiver, an opening is formed in the top surface of the case, and an infrared-transparent window member is attached to the top surface to close the opening. Sapphire, barium fluoride, silicon, germanium or so on is used for the window member (see, for example, Patent Literature 1).

### CITATION LIST

### Patent Literature

### [PTL 1]

### JP-A-H10-332585

### SUMMARY OF INVENTION

### Technical Problem

However, sapphire, barium fluoride, silicon, and germanium are crystalline materials, which are therefore less workable and normally used in a platy shape. The optical gas sensor in which a platy crystalline material is used as a window member has a problem of poor sensitivity.

The present invention has been made in view of the foregoing circumstances and therefore has an object of providing an optical cap component that can give good sensitivity to an infrared light absorption-based optical gas sensor.

### Solution to Problem

An optical cap component according to the present invention includes: a window member formed of a lens-shaped infrared transmitting glass; and a cap member including a cylindrical sidewall portion having openings on both a distal end side and a base end side, wherein the window member is fixed to cover the opening on the distal end side of the cap member. The infrared transmitting glass has better workability than the crystalline materials, including sapphire, germanium, and silicon, and can be easily molded in the shape of a lens. By making the window member into the shape of a lens, the window member has an excellent light-gathering capability, which enables improvement in the sensitivity of an infrared light absorption-based optical gas sensor. Note that the term “infrared transmitting glass” used in the present invention means a glass having a maximum transmittance of 30% or more in a wavelength range of 1 to 6 μm when having a thickness of 1 mm.

In the optical cap component according to the present invention, the infrared transmitting glass is preferably a tellurite-based glass. While quartz glass and borosilicate glass can transmit infrared light having a wavelength of no more than about 3.0 μm, tellurite-based glasses can transmit light having a wavelength of up to about 6.0 μm and, therefore, has excellent infrared transmission characteristics.

In the optical cap component according to the present invention, the tellurite-based glass preferably contains, as a composition in terms of % by mole, 30 to 90% TeO₂, 0 to 40% ZnO, 0 to 30% RO (where R represents at least one selected from among Mg, Ca, Sr, and Ba), and 0 to 30% R′₂O (where R′ represents at least one selected from among Li, Na, and K).

In the optical cap component according to the present invention, the infrared transmitting glass preferably has a maximum transmittance of 50% or more in a wavelength range of 1 to 6 μm when having a thickness of 1 mm.

In the optical cap component according to the present invention, the infrared transmitting glass preferably has a coefficient of thermal expansion of 250×10⁻⁷/° C. or less in a range of 0 to 300° C. Thus, deformation due to a temperature change can be reduced.

In the optical cap component according to the present invention, the window member is preferably fixed to the cap member by a bonding material.

In the optical cap component according to the present invention, the bonding material preferably contains 50 to 100% by volume glass powder and 0 to 50% by volume refractory filler powder.

In the optical cap component according to the present invention, the glass powder is preferably substantially free of PbO and halogen. Halogen includes not only simple substances of halogen, such as fluorine, chlorine, bromine, and iodine, but also halides. The halides refer to fluorides, chlorides, bromides, and iodides. As used herein, “substantially free of PbO and halogen” refers to the case where the content of each of PbO and halogen in the glass composition is 1000 ppm or less.

In the optical cap component according to the present invention, an antireflection film is preferably formed on a surface of the window member. By doing so, the light transmittance in the infrared range can be easily improved.

In the optical cap component according to the present invention, the cap member preferably has a coefficient of thermal expansion of 250×10⁻⁷/° C. or less in a range of 0 to 300° C. Thus, deformation due to a temperature change can be reduced.

In the optical cap component according to the present invention, it is preferred that the cap member includes an end wall portion continuing into a distal end of the sidewall portion and the opening is provided in a center of the end wall portion.

In the optical cap component according to the present invention, a proportion of a diameter of the opening in the end wall portion to an inside diameter of the sidewall portion is preferably 10% or more.

The optical cap component according to the present invention preferably includes a flange portion extending radially outward on the base end side of the sidewall portion.

The optical cap component according to the present invention is preferably used for an optical sensor.

### Advantageous Effects of Invention

The present invention enables provision of an optical cap component that can give good sensitivity to an infrared light absorption-based optical gas sensor.

### BRIEF DESCRIPTION OF DRAWINGS

FIG. 1 is a schematic cross-sectional view showing an optical cap component according to a first embodiment of the present invention.

FIG. 2 is a schematic cross-sectional view showing an optical cap component according to a second embodiment of the present invention.

FIG. 3 is a schematic cross-sectional view showing an optical cap component according to a third embodiment of the present invention.

FIG. 4 is a schematic cross-sectional view showing an optical cap component used in a simulation under Conditions 1.

FIG. 5 is a schematic cross-sectional view showing an optical cap component used in a simulation under Conditions 2.

### DESCRIPTION OF EMBODIMENTS

Hereinafter, a description will be given of embodiments of an optical cap component according to the present invention.

### (1) First Embodiment

FIG. 1 is a schematic cross-sectional view showing an optical cap component according to a first embodiment of the present invention.

In this embodiment, an optical cap component 1 includes: a window member 2 formed of a lens-shaped infrared transmitting glass; and a cap member 3. A sensor light-receiving part 5 is provided just below the window member 2. The cap member 3 includes a sidewall portion 3c having openings at both ends thereof. Specifically, the sidewall portion 3c has a distal end and a base end, an opening 3a is formed on the distal end side, an opening 3b is formed on the base end side. Furthermore, the sidewall portion is in a cylindrical shape having an approximately constant inside diameter throughout the entire length and the diameters of the openings on the distal end side and base end side are approximately equal to the inside diameter of the sidewall portion. The window member 2 is fixed to cover the opening 3a on the distal end side of the cap member 3.

An example of a method for fixing the window member 2 to the cap member 3 is a method of applying a bonding material 4, such as a low-melting-point glass, an adhesive or a solder, between the window member 2 and the cap member 3. Alternatively, the window member 2 itself may be melted and fusion-bonded to the cap member 3. Still alternatively, if the cap member 3 has a higher coefficient of thermal expansion than the window member 2, the window member 2 can be fixed to the cap member 3 by placing the window member 2 into the cap member 3 and then subjecting them to heating and cooling to thus tighten the window member 2 with the cap member 3 using a difference in heat shrinkage ratio between the cap member 3 and the window member 2.

The optical cap component will be described below on an element-by-element basis.

(Window Member 2)

The window member 2 has the shape of a lens. Therefore, it has an excellent light-gathering capability, which enables area reduction of the sensor light-receiving part and attendant size reduction of the device. Furthermore, the received light intensity is increased, which is likely to improve the sensitivity of the sensor. No particular limitation is placed on the shape of the lens, but a convexo-convex shape (for example, a spherical shape), a plano-convex shape, and a meniscus shape are preferred in view of light-gathering capability.

The window member 2 is formed of an infrared transmitting glass. The infrared transmitting glass is preferably a tellurite-based glass likely to have a good light transmittance in the infrared range.

The tellurite-based glass preferably contains, as a composition in terms of % by mole, 30 to 90% TeO₂, 0 to 40% ZnO, 0 to 30% RO (where R represents at least one selected from among Mg, Ca, Sr, and Ba), and 0 to 30% R′₂O (where R′ represents at least one selected from among Li, Na, and K). The reasons why the composition range of the glass is limited as just described will be described below. Note that in the following description of the contents of components, “%” refers to “% by mole” unless otherwise specified.

TeO₂ is a component for forming the glass network. Furthermore, TeO₂ has the effect of decreasing the glass transition point and increasing the refractive index. When the glass transition point is lowered, pressability increases. When the refractive index is increased, the focal length decreases and the optical sensor or the like can therefore be easily reduced in size. The content of TeO₂ is preferably 30 to 90%, more preferably 40 to 80%, and particularly preferably 50 to 70%. If the content of TeO₂ is too small, this makes vitrification less likely. On the other hand, if the content of TeO₂ is too large, the light transmittance in the visible range decreases, so that the glass may not be able to be used in applications requiring light transmittance in the visible range from a design viewpoint or other viewpoints.

ZnO is a component for increasing the thermal stability. The content of ZnO is preferably 0 to 40%, more preferably 10 to 35%, and particularly preferably 15 to 30%. If the content of ZnO is too large, this makes vitrification less likely.

RO (where R represents at least one selected from among Mg, Ca, Sr, and Ba) is a component for increasing the stability of vitrification without decreasing the light transmittance in the infrared range. The content of RO is preferably 0 to 30%, more preferably 1 to 25%, still more preferably 2 to 20%, and particularly preferably 3 to 15%. If the content of RO is too large, this makes vitrification less likely.

The content of each of MgO, CaO, SrO, and BaO is preferably 0 to 30%, more preferably 1 to 25%, still more preferably 2 to 20%, and particularly preferably 3 to 15%. Among the RO components, BaO has the highest effect of increasing the stability of vitrification. Therefore, positive incorporation of BaO as RO facilitates vitrification.

R′₂O (where R′ represents at least one selected from among Li, Na, and K) is a component for improving the light transmittance in the visible range. The content of R′₂O is preferably 0 to 30%, more preferably 1 to 25%, still more preferably 2 to 20%, and particularly preferably 3 to 15%. If the content of R′₂O is too large, the chemical durability is liable to decrease.

The content of each of Li₂O, Na₂O, and K₂O is preferably 0 to 30%, more preferably 1 to 25%, still more preferably 2 to 20%, and particularly preferably 3 to 15%.

Aside from the above components, the following components may be incorporated into the glass composition.

La₂O₃, Gd₂O₃, and Y₂O₃ are components for decreasing the liquidus temperature to increase the stability of vitrification, without decreasing the light transmittance in the infrared range. The content of La₂O₃+Gd₂O₃+Y₂O₃ is preferably 0 to 50%, more preferably 1 to 30%, and particularly preferably 1 to 15%. If the content of these components is too large, this makes vitrification less likely. In addition, the glass transition point rises, so that the press moldability is likely to decrease. Note that among these components La₂O₃ has the highest effect of increasing the stability of vitrification. Therefore, positive incorporation of La₂O₃ facilitates vitrification. As used herein, “La₂O₃+Gd₂O₃+Y₂O₃” means the total of the contents of La₂O₃, Gd₂O₃, and Y₂O₃. The content of each of La₂O₃, Gd₂O₃, and Y₂O₃ is preferably 0 to 50%, more preferably 0 to 30%, and particularly preferably 0.5 to 15%.

SiO₂, B₂O₃, P₂O₅, GeO₂, and Al₂O₃ decrease the light transmittance in the infrared range. Therefore, the content of each of them is preferably less than 1% and, more preferably, the infrared transmitting glass is substantially free of these components.

The following elements Ce, Pr, Nd, Sm, Eu, Tb, Ho, Er, Tm, Dy, Cr, Mn, Fe, Co, Cu, V, Mo, and Bi significantly absorb light in a visible range of about 400 to 800 nm. Therefore, if the infrared transmitting glass is substantially free of these components, a glass having high light transmittances over a wide visible range can be easily obtained.

Pb, Cs, and Cd are environmentally harmful substances. Therefore, the infrared transmitting glass is preferably substantially free of these substances.

The glass having the composition as described above is likely to have a maximum transmittance of preferably 50% or more, more preferably 60% or more, and particularly preferably 70% or more in a wavelength range of 1 to 6 μm when having a thickness of 1 mm.

Furthermore, the coefficient of thermal expansion of the infrared transmitting glass is, in a range of 0 to 300° C., preferably 250×10⁻7/° C. or less, more preferably 220×10⁻⁷/° C. or less, still more preferably 200×10⁻⁷/° C. or less, yet still more preferably 180×10⁻7° C. or less, and particularly preferably 160×10⁻⁷/° C. or less. If the coefficient of thermal expansion is too large, the infrared transmitting glass is likely to deform upon temperature change, which may decrease the light-gathering capability to decrease the sensitivity of the sensor. Although no particular limitation is placed on the lower limit of the coefficient of thermal expansion, it is, on a realistic level, 50×10⁻⁷/° C. or more.

The larger the effective diameter of incidence and the larger the angle of incidence on the window member 2, the larger the spherical aberration becomes. With the same focal length, the higher the refractive index, the smaller the curvature of the window member 2 becomes and the smaller the angle of incidence can be made. Therefore, the spherical aberration becomes small. The refractive index of the glass having the composition as described above is about 1.9 to about 2.1, which is higher than the refractive indices of sapphire, quartz glass, and borosilicate glass of about 1.5 to about 1.8, and the spherical aberration of the glass is therefore likely to become small.

For the purpose of improving the infrared light transmittance, an antireflection film may be formed on a surface (a light incident surface or a light outgoing surface) of the window member 2.

An example of the structure of the antireflection film is a multi-layer film in which low-refractive index layers and high-refractive index layers are alternately laid one on top of the other. Examples of materials forming the antireflection film include: oxides, such as niobium oxide, titanium oxide, lanthanum oxide, tantalum oxide, yttrium oxide, gadolinium oxide, tungsten oxide, hafnium oxide, and aluminum oxide; fluorides, such as magnesium fluoride and calcium fluoride; nitrides, such as silicon nitride; silicon; germanium; and zinc sulfide. Other than the multi-layer film, a monolayer film made of silicon oxide or so on can also be used as the antireflection film.

Examples of a method for forming the antireflection film include the vacuum deposition method, the ion plating method, and the sputtering method. The antireflection film may be formed after the fixing of the window member 2 to the cap member 3 or may be first formed on the window member 2, followed by the fixing of the window member 2 to the cap member 3. However, in the latter case, the antireflection film is likely to peel off in the fixing process. Therefore, the former case is more preferred.

(Cap Member 3)

The material for the cap member 3 may be metal or ceramics, but metal, such as Hastelloy (registered trademark), Inconel (registered trademark) or SUS, is preferred in view of workability.

The coefficient of thermal expansion of the cap member is, in a range of 0 to 300° C., preferably 250×10⁻⁷/° C. or less, more preferably 220×10⁻⁷/° C. or less, still more preferably 200×10⁻⁷/° C. or less, yet still more preferably 180×10⁻⁷/° C. or less, and particularly preferably 160×10⁻⁷/° C. or less. If the coefficient of thermal expansion is too large, the cap member is likely to deform upon temperature change, which may decrease the light-gathering capability to decrease the sensitivity of the sensor. Although no particular limitation is placed on the lower limit of the coefficient of thermal expansion, it is, on a realistic level, 50×10⁻⁷/° C. or more.

(Bonding Material 4)

The bonding material 4 is required to have chemical durability and thermal resistance and is therefore preferably, not a resin-based material, but a glass-based material. Examples of glass for use in the bonding material include silver oxide-based glasses, phosphate-based glasses, bismuth oxide-based glasses, and silver phosphate-based glasses. Particularly, silver phosphate-based glasses have low softening points, can provide sealing at lower temperatures, and are therefore suitable for the sealing of a heat-labile window member made of a tellurite-based glass or so on. Because PbO and halogen are harmful, the glass is preferably substantially free of these components.

In order to improve the mechanical strength or adjust the coefficient of thermal expansion, the bonding material 4 may contain, in addition to glass powder made of the glass as described above, a refractory filler. The mixture proportion between them is preferably 50 to 100% by volume glass powder to 0 to 50% by volume refractory filler, more preferably 70 to 99% by volume glass powder to 1 to 30% by volume refractory filler, and still more preferably 80 to 95% by volume glass powder to 5 to 20% by volume refractory filler. If the content of the refractory filler is too large, the proportion of the glass powder becomes relatively small, so that a desired fluidity is less likely to be secured.

No particular limitation is placed on the type of the refractory filler and various materials can be selected for the refractory filler, but materials less reactable with the above glass powder are preferred.

Specifically, examples of the refractory filler that can be used include NbZr(PO₄)₃, Zr₂WO₄(PO₄)₂, zirconium phosphate, zircon, zirconia, tin oxide, aluminum titanate, quartz, β-spodumene, mullite, titania, quartz glass, β-eucryptite, β-quartz, willemite, cordierite, and solid solutions of NaZr₂(PO₄)₃ family materials, such as Sr_{0.5}Zr₂(PO₄)₃. These refractory fillers may be used alone or in a mixture of two or more of them. The preferred refractory fillers to be used are those having an average particle diameter D50 of about 0.2 to 20 μm.

The glass transition point of the bonding material 4 is preferably 300° C. or less and particularly preferably 250° C. or less. Furthermore, the softening point is preferably 350° C. or less and particularly preferably 310° C. or less. If the glass transition point and the softening point are too high, the firing temperature (sealing temperature) rises, so that the window member 2 may deform or degrade during firing. No particular limitation is placed on the lower limits of the glass transition point and the softening point, but, on a realistic level, the glass transition point is 130° C. or more and the softening point is 180° C. or more.

The coefficient of thermal expansion of the bonding material 4 in a range of 30 to 150° C. is preferably 250×10⁻⁷/° C. or less, more preferably 230×10⁻⁷/° C. or less, and particularly preferably 200×10⁻⁷/° C. or less. If the coefficient of thermal expansion is too high, an expansion difference from the member to be sealed causes easy peeling of the bonding material 4. Although no particular limitation is placed on the lower limit of the coefficient of thermal expansion, it is, on a realistic level, 50×10⁻⁷/° C. or more.

Next, a description will be given of a method for producing the bonding material 4.

First, powder of raw materials compounded to give a desired composition is melted at about 700 to 1600° C. for about one to two hours until a homogeneous glass is obtained. Subsequently, the molten glass is formed in the shape of a film or the like, then ground, and classified, thus producing glass powder. The average particle diameter D50 of the glass powder is preferably about 2 to 20 μm. As necessary, refractory filler powder of various types is added to the glass powder. In this manner, a bonding material 4 is obtained. As will be described below, the bonding material 4 can be used in the form of, for example, a sintered body (a tablet) having a desired shape.

First, an organic resin and an organic solvent are added to the glass powder (or mixed powder of the glass powder and the refractory filler powder), thus forming a slurry. Thereafter, the slurry is loaded into a granulator, such as a spray dryer, thus producing granules. In doing so, the granules are heat-treated at such a temperature (about 100 to 200° C.) that the organic solvent volatilizes. Furthermore, the produced granules are charged into a mold designed with a predetermined size and dry-pressed into an annular shape, thus producing a pressed body. Next, in a heat-treating furnace, such as a belt furnace, the binder remaining in the pressed body is decomposed and volatilized and the pressed body is sintered at a temperature of about the softening point of the glass powder to produce a sintered body. The sintering in the heat-treating furnace may be performed multiple times. When the sintering is performed multiple times, the strength of the sintered body is improved, so that chipping, breakage, and the like of the sintered body can be prevented.

The organic resin is a component for binding powder particles together to granulate them and the amount thereof added is preferably 0 to 20% by mass relative to 100% by mass of the glass powder (or the mixed powder of the glass powder and the refractory filler powder). Materials that can be used as the organic resin include acrylic resin, ethylcellulose, polyethylene glycol derivatives, nitrocellulose, polymethylstyrene, polyethylene carbonate, and methacrylic acid esters. Particularly, acrylic resin is preferred because its good pyrolytic property.

If the organic solvent is added in granulating the glass powder (or the mixed powder of the glass powder and the refractory filler powder), the powder can be easily granulated by a spray dryer or other means and the granularity of the granules can be easily controlled. The amount of the organic solvent added is preferably 5 to 35% by mass relative to 100% by mass of sealing material. Materials that can be used as the organic solvent include N,N′-dimethylformamide (DMF), alpha-terpineol, higher alcohols, gamma-butyrolactone (gamma-BL), tetralin, butyl carbitol acetate, ethyl acetate, isoamyl acetate, diethylene glycol monoethyl ether, diethylene glycol monoethyl ether acetate, benzyl alcohol, toluene, 3-methoxy-3-methylbutanol, triethylene glycol monomethyl ether, triethylene glycol dimethyl ether, dipropylene glycol monomethyl ether, dipropylene glycol monobutyl ether, tripropylene glycol monomethyl ether, tripropylene glycol monobutyl ether, propylene carbonate, dimethyl sulfoxide (DMSO), and N-methyl-2-pyrrolidone. Particularly, toluene is preferred because it has a good ability to dissolve organic resins or the like and volatilizes well at about 150° C.

The produced sintered body is placed on the opening 3a of the cap member 3 and thereafter served in the process for sealing between the window member 2 and the cap member 3. Alternatively, the bonding material 4 may be used as a paste by adding a vehicle containing a solvent, a binder, and so on to the glass powder (or the mixed powder of the glass powder and the refractory filler powder).

### (2) Second Embodiment

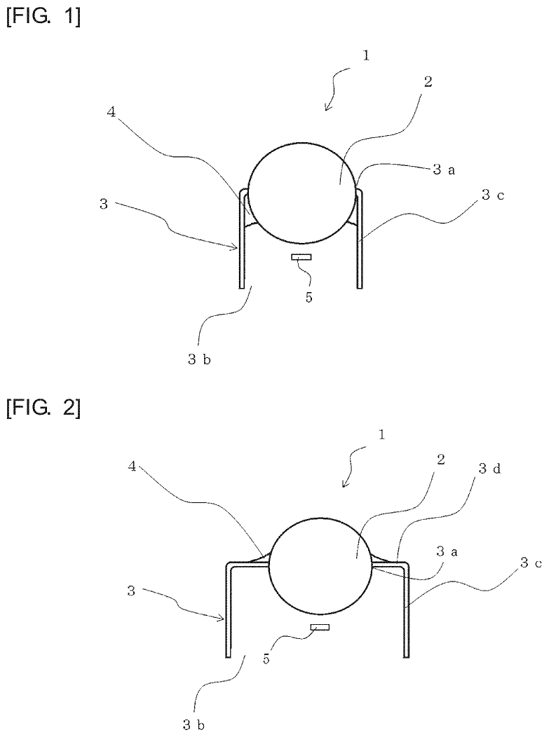

FIG. 2 is a schematic cross-sectional view showing an optical cap component according to a second embodiment of the present invention. A difference from the optical cap component according to the first embodiment is that in the second embodiment the optical cap component further includes an annular end wall portion 3d located on the distal end side of the sidewall portion 3c and continuing from the sidewall portion 3c and the window member 2 is fixed into the opening 3a located in the center of the end wall portion 3d. By the provision of the end wall portion 3d, the window member 2 can be easily fixed to the cap member 3. Furthermore, the mechanical strength of the cap member 3 increases, so that the reliability as an optical cap component increases. In addition, the optical axes of the cap member 3 and the window member 2 can be easily aligned.

In the cap member 3, the proportion of the diameter of the opening 3a in the end wall portion 3d to the diameter of the cylindrical sidewall portion 3c is preferably 10% or more, more preferably 30% or more, even more preferably 40% or more, still more preferably 50% or more, yet still more preferably 60% or more, and particularly preferably 70% or more. If the above proportion is too small, the amount of light incident on the window member 2 is likely to be small, so that the sensitivity of the sensor is likely to decrease. In order to obtain the above effects, the upper limit of the above proportion is preferably not more than 95% and particularly preferably not more than 90%.

### (3) Third Embodiment

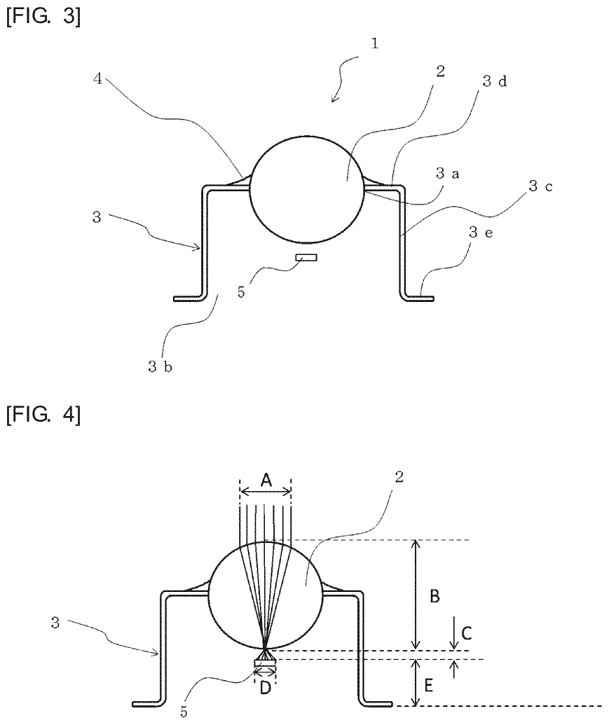

FIG. 3 is a schematic cross-sectional view showing an optical cap component according to a third embodiment of the present invention. A difference from the optical cap component according to the second embodiment is that in the third embodiment, additionally, an annular flange portion 3e located on the base end side of the sidewall portion 3c and continuing from the sidewall portion 3c extends outward. By doing so, the mechanical strength of the cap member 3 can be improved. Furthermore, the cap member 3 can be easily fixed to a mounting surface of the sensor body.

The present invention is not limited to the above embodiments and can be implemented in various forms without departing from the gist of the present invention.

Simulations were made in two patterns under the following Conditions 1 and Conditions 2 to examine how much the light-gathering capability changes depending on the shape of the window member 2. The index for the light-gathering capability is (the amount of light received by the sensor light-receiving part)/(the amount of incident infrared light)×100(%). The incident infrared light was collimated light.

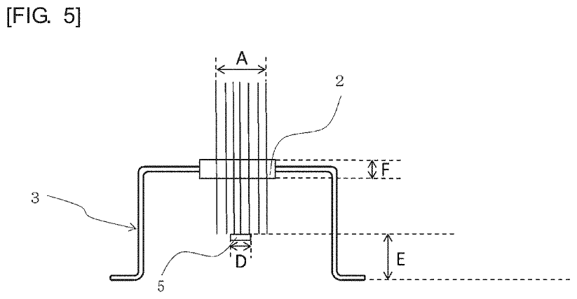

FIG. 4 is a schematic cross-sectional view showing an optical cap component used in a simulation under Conditions 1. FIG. 5 is a schematic cross-sectional view showing an optical cap component used in a simulation under Conditions 2. In each simulation, light loss by light reflection at the surface of the window member and other factors was ignored.

(Conditions 1)

The effective diameter A of incidence of infrared light: 3.5 mm

The diameter D of the disk-shaped sensor light-receiving part 5: 1.0 mm

The distance E between the base end of the cap member 3 and the top surface of the sensor light-receiving part 5: 6.6 mm

The distance C between the window member 2 and the top surface of the sensor light-receiving part 5: 0.5 mm

The window member 2: a pearl-like tellurite-based infrared transmitting glass having a refractive index (nd) of 2.01

The diameter B of the window member 2: 6 mm

(Conditions 2)

The effective diameter A of incidence of infrared light: 3.5 mm

The diameter D of the disk-shaped sensor light-receiving part 5: 1.0 mm

The distance E between the base end of the cap member 3 and the top surface of the sensor light-receiving part 5: 6.6 mm

The window member 2: a platy tellurite-based infrared transmitting glass having a refractive index (nd) of 2.01

The thickness F of the window member 2: 1 mm

As a result of the simulation, under Conditions 1, (the amount of light received by the sensor light-receiving part)/(the amount of incident infrared light)×100=100(%). On the other hand, under Conditions 2, (the amount of light received by the sensor light-receiving part)/(the amount of incident infrared light)×100≅8.1(%). It can be seen from the above results that, with the use of the optical cap component according to the present invention, the light-gathering capability was increased, so that the sensor sensitivity could be significantly improved. Specifically, according to the above simulation results, Conditions 1 where the optical cap component including a lens-shaped window member was used could achieve a sensor sensitivity about 12 times greater than Conditions 2 where the optical cap component including a platy window member was used.

### REFERENCE SIGNS LIST

1 optical cap component
2 window member
3 cap member
3a opening
3b opening
3c sidewall portion
3d end wall portion
3e flange portion
4 bonding material
5 sensor light-receiving part
A effective diameter of incidence
B diameter of window member
C distance between window member and top surface of sensor light-receiving part
D diameter of sensor light-receiving part
E distance between base end of cap member and top surface of sensor light-receiving part
F thickness of window member

1. An optical cap component comprising:
a window member formed of a lens-shaped infrared transmitting glass; and
a cap member including a cylindrical sidewall portion having openings on both a distal end side and a base end side, wherein
the window member covers the opening on the distal end side of the cap member,
the cap member has a higher coefficient of thermal expansion than the window member, and the window member is fixed to the cap member due to a difference in heat shrinkage ratio between the cap member and the window member.

2. The optical cap component according to claim 1, wherein the infrared transmitting glass is a tellurite-based glass.

3. The optical cap component according to claim 2, wherein the tellurite-based glass contains, as a composition in terms of % by mole, 30 to 90% TeO₂, 0 to 40% ZnO, 0 to 30% RO (where R represents at least one selected from among Mg, Ca, Sr, and Ba), and 0 to 30% R′₂O (where R′ represents at least one selected from among Li, Na, and K).

4. The optical cap component according to claim 1, wherein the infrared transmitting glass has a maximum transmittance of 50% or more in a wavelength range of 1 to 6 μm at a thickness of 1 mm.

5. The optical cap component according to claim 1, wherein the infrared transmitting glass has a coefficient of thermal expansion of 250×10⁻⁷/° C. or less in a range of 0 to 300° C.

6. The optical cap component according to claim 1, wherein an antireflection film is provided on a surface of the window member.

7. The optical cap component according to claim 1, wherein the cap member has a coefficient of thermal expansion of 250×10⁻⁷/° C. or less in a range of 0 to 300° C.

8. The optical cap component according to claim 1, wherein the cap member includes an end wall portion extending to a distal end of the cylindrical sidewall portion, and the opening on the distal end side of the cap member is provided in a center of the end wall portion.

9. The optical cap component according to claim 8, wherein a proportion of a diameter of the opening in the end wall portion to an inside diameter of the cylindrical sidewall portion is 10% or more.

10. The optical cap component according to claim 1, further comprising a flange portion extending radially outward on the base end side of the cylindrical sidewall portion.

11. The optical cap component according to claim 1, wherein the optical cap component is used in an optical sensor.
